(19) United States
(12) Patent Application Publication
(10) Pub. No.: US 2009/0072703 A1
(43) Pub. Date: Mar. 19, 2009

(54) LOW-PRESSURE DISCHARGE LAMP

(75) Inventors: Piet Antonis, Eindhoven (NL); Maurice Jacques Sofie Elisabeth Sensen, Eindhoven (NL); Rolf Erwin De Man, Eindhoven (NL); Gerardus Arnoldus Rita Van Dijk, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/298,923

(22) PCT Filed: Apr. 24, 2007
(86) PCT No.: PCT/IB2007/051490

§ 371 Date: Oct. 29, 2008

(30) Foreign Application Priority Data
May 1, 2006 (EP) 06113335.1

(51) Int. Cl. H01J 63/04

(52) U.S. Cl. 313/485

(57) ABSTRACT

The invention relates to an improved low-pressure gas discharge lamp comprising a gas discharge vessel (1) surrounding a discharge space (2), containing a gas filling, and further comprising means to generate an electromagnetic field (3) and means for generating and maintaining a low-pressure gas discharge. The lamp is characterized in that the discharge lamp is provided with a first phosphor coating on a surface of the gas discharge vessel and with a second phosphor coating, the second phosphor coating being provided on a surface of the lamp that is more remote from the discharge space compared to the first phosphor coating, and the first phosphor coating being selected from the group of thermally stable phosphors. The low-pressure discharge lamp provides increased efficiency and reduced solarisation as compared to commercially available low-pressure discharge lamps.

The invention relates to a low-pressure gas discharge lamp comprising a gas discharge vessel surrounding a discharge space containing a gas filling, and comprising means to generate an electromagnetic field for generating and maintaining a low-pressure gas discharge.

Light generation in low-pressure gas discharge lamps is based on the principle that charge carriers, particularly electrons but also ions, are accelerated so strongly by an electric field of the lamp that collisions with the gas atoms or molecules in the gas filling of the lamp cause these gas atoms or molecules to be excited or ionized. When the atoms or molecules of the gas filling return to a lower energetic state, a more or less substantial part of the excitation energy is converted to radiation.

Conventional low-pressure gas discharge lamps comprise mercury in the gas filling and, in addition, are equipped with a phosphor coating on the gas discharge vessel. A drawback of the mercury low-pressure gas discharge lamps resides in that mercury vapor primarily emits radiation in the high-energy, yet invisible UV-C range of the electromagnetic spectrum, which radiation must first be converted by the phosphors to visible radiation having a much lower energy level. In this process, the energy difference is converted to undesirable thermal radiation (“Stokes losses”), which reduces the discharge efficiency.

Other low-pressure gas discharge lamps, such as those described in U.S. Pat. No. 6,731,070, use a gas filling with a chalcogenide, which produces a lot of visible and near visible radiation. Conversion into visible radiation by phosphors therefore entails reduced Stokes losses, which is an advantage. The lamp, however, requires high temperatures in order to generate the optimum vapour pressures needed for high discharge efficiencies.

Lamps with fillings such as metal-halide or mercury fillings produce at least some short-wave UV light (of UV-B and UV-C type). Exposure of the glass parts of the lamp to short-wave UV light may lead to damage to the glass structure. This so-called solarization leads to a decrease of the transmission of the glass parts of the lamp, and may even lead to a brownish discoloring of the glass.

It is an object of the present invention to provide a low-pressure gas discharge lamp with an improved gas discharge efficiency.

According to the invention, this object is achieved by a low-pressure gas discharge lamp as described in claim 1. By providing the gas discharge lamp with a first and second phosphor coating, the first phosphor coating being selected from the group of thermally stable phosphors, the gas discharge efficiency is improved as compared to known gas discharge lamps. Preferably, the first phosphor coating is provided on the inside surface of the gas discharge vessel. A broad range of fillings may be used in a lamp according to the invention, without creating problems such as solarisation. For instance, it now becomes possible to benefit from short wave UV-B and UV-C light without having to use expensive glass that is transparent to UV-B and UV-C light. Indeed, before the light reaches the glass gas-discharge vessel, at least part of the short wave UV light is converted to light of longer wavelengths by the first phosphor coating. When the light finally hits the glass it is less harmful to it, i.e. induces less discolouring and solarization than the lamp according to the state of the art. An additional advantage occurs when starting up the lamp, i.e. when the vapour pressure of the filling is not yet sufficient and the gas discharge isdominated by the noble gas. One of the characteristics of the noble gas discharge is an emission with a very low wavelength, typically below 200 nm, and usually referred to as deep UV light. The lamp according to the invention converts at least part of this very low wavelength light into longer wavelength light before the light actually hits the glass parts of the lamp.

By using the first phosphor coating, the lamp in accordance with the invention has a visual efficiency which is substantially higher than that of conventional low-pressure discharge lamps. The visual efficiency, expressed in lumen/Watt, is the ratio between the brightness of the radiation in a specific visible wavelength range and the energy for generating the radiation. The high visual efficiency of the lamp in accordance with the invention means that a specific quantity of light is obtained at a lower power consumption. Moreover, by using at least two phosphors, it is possible to select these such that the lamp offers an improved colour rendition.

When referring to thermally stable phosphors in the context of this application, phosphors are meant that do show an efficiency of the conversion of UV light to longer wavelength (f.i. visible) light that is substantially unaffected by temperatures higher than 100° C., preferably higher than 150° C., and most preferably higher than 200° C. Preferred first phosphors are selected from the group consisting of metal aluminates and/or metal oxides.

Particularly suitable phosphors with high thermal quenching properties include green phosphors such as SON [(Sr,Ba)Si₂N₂O₂:Eu], (Ba,Sr)O₂N₂:Eu, BOSE [(Ba,Sr)₂SiO₄:Eu] and Y₂SiO₅:Ce,Tb; yellow/orange phosphors such as OSE [(Ca,Sr)₂SiO₄:Eu], CaAlSiN₃:Ce and YAG:Ce [Y₃Al₅O₁₂:Ce]; white phosphors such as Ca₂Mg₂V₂O₁₂:Eu, and red phosphors such as YOS [Y₂O₂S:Eu], SSNE [Sr₂Si₅N₅:Eu], La₃PO₇:Eu and CaAlSiN₃:Ce. These phosphors are preferably used as a second phosphor below about 200° C.

Particularly suitable phosphors with low thermal quenching properties include blue phosphors, such as BAM [(Ba,Mg)Al₁₀O₁₇:Eu]; green phosphors such as CBT [(Ce,Gd)MgB₅O₁₀:Tb], CAT[(Ce,Tb)MgAl₁₁O₁₉], BAM-green [BaMg₂Al₁₆O₂₇:Eu,Mn], SSON [SrSi₂N₂O₂:Eu] and SrGa₂S₄:Eu; orange phosphors such as Mg₄GeO_{5.5}F:Mn and Sr₂Si₅N₅:Eu; SrS:Eu; and red phosphors such as YOX [Y₂O₃:Eu], Y-vanadate [YVO4:Eu], Y(P,V)O₄:Eu, and Y(P,V)O₄:Eu,Bi. These phosphors are preferably used as a first phosphor and typically above 200° C. Particularly preferred first phosphors include barium magnesium aluminate, cerium terbium magnesium aluminate and yttrium oxide, and combinations thereof.

In another preferred embodiment according to the invention, the low-pressure gas discharge lamp is characterized in that the first phosphor coating comprises a UV-A and/or blue emitting phosphor, and the second phosphor layer comprises a phosphor that is excited when exposed to UV-A and/or blue radiation. In this embodiment, the content of the first phosphor layer at least partly converts to blue light, whereas the content in the second phosphor layer converts blue light further to light with the desired wavelength. Particularly preferred in this embodiment are BAM [(Ba,Mg)Al₁₀O₁₇:Eu] as a first phosphor, optionally in a mixture with other phosphors, and YAG:Ce [Y₃Al₅O₁₂:Ce] as a second phosphor, optionally in a mixture with other phosphors.

In another preferred embodiment according to the invention, the low-pressure gas discharge lamp is characterized in that the gas discharge vessel is provided with an infrared reflective coating. Infrared reflective coatings are known per se and are normally used to improve the efficiency of gas discharge lamps. The efficiency of the lamp is improved by the fact that a substantial portion of the infrared energy emitted by the lamp is reflected back toward the discharge area, thereby increasing the temperature in the discharge area without an increase of the input power from the excitation source being necessary. However, when using short wave UV light, such as UV-B and UV-C light, the use of infrared reflector layers will usually lead to a decrease in efficiency, since a substantial portion of the UV-B and UV-C radiation will be absorbed by the infrared reflector layer. This is especially the case when infrared reflector layers are used having a strong absorption below 350 nm wavelength, such as for instance indium doped tin oxide (ITO) and fluor doped tin oxide (FTO). Highly conductive and transparent aluminum- and gallium-doped zinc oxide (ZnO:Al and ZnO:Ga) thin films may also be used.

A particularly preferred low-pressure gas discharge lamp according to the invention is characterized in that the infrared reflective coating is positioned on an outside surface of the gas discharge vessel. This embodiment of the lamp shows an improved efficiency compared to a lamp without the infrared reflective coating, especially when the infrared reflective coating is selected from the group of metal oxides, in particular tin oxides, more in particular ITO and/or FTO.

According to the invention, the low-pressure gas discharge lamp is provided with a second phosphor coating. This second phosphor coating can in principle be applied to the discharge vessel and/or to the outer lamp bulb, either over substantially the entire surface of it, or only over parts thereof. It should be understood that according to the invention, the second phosphor coating is provided on a surface which is more remote from the gas discharge space than the first phosphor coating. A preferred embodiment has a gas discharge vessel, provided with a second phosphor coating on its outside surface. Such a configuration can be easily manufactured and, moreover, assures that already converted light from the first coating may be converted further or partly converted to light in a longer wavelength range. Another preferred option is to provide a low-pressure gas discharge lamp, the lamp bulb of which is provided, preferably on its outside surface, with the second phosphor coating. Providing the second phosphor coating more remote from the gas discharge space in general allows the use of the more common phosphors, i.e. the less stable phosphors. Such phosphors are known per se and include rare earth phosphors, such as rare earth triphosphors, but also halophosphate phosphors or any other phosphor known in the art to absorb UV light.

Within the scope of the invention, it may be preferred that the gas discharge vessel and/or the lamp bulb comprise further phosphor coatings on their outside surface. The remaining UV-A radiation emitted by the low-pressure gas discharge lamp in accordance with the invention is not absorbed by the customary glass types, but goes through the walls of the discharge vessel substantially free of losses. Therefore, additional phosphor coatings can be provided on the outside of the gas discharge vessel and/or lamp bulb to at least partly convert this UV-A radiation to visible light, and further increase the lamp's efficiency.

The invention will now be further illustrated by way of the following non-limitative embodiments, wherein:

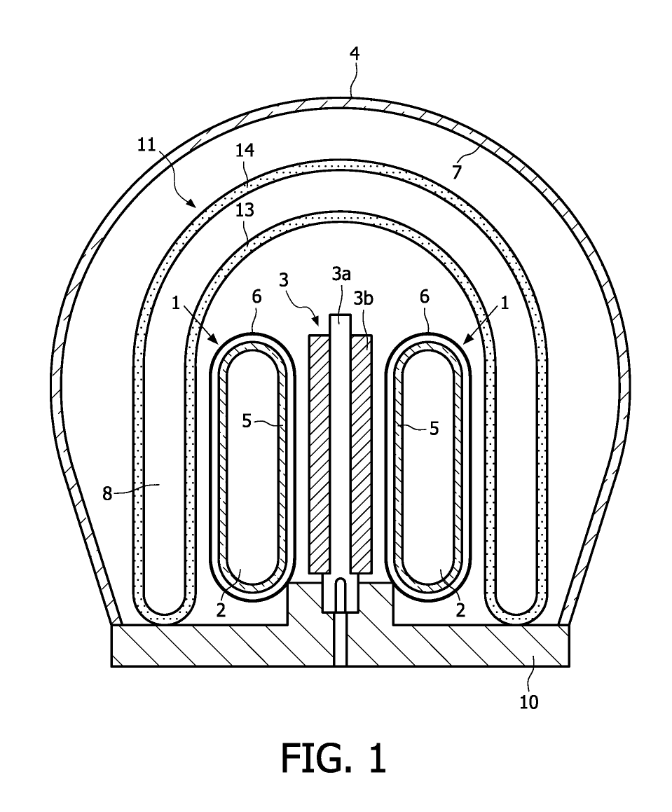

FIG. 1 shows an elevational view of a first embodiment of the low-pressure discharge lamp according to the invention, and

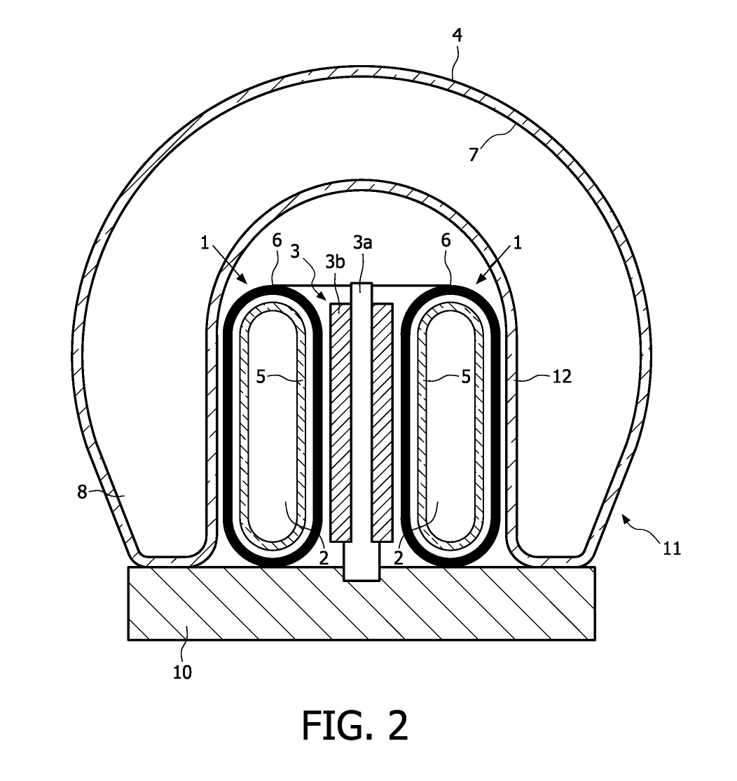

FIG. 2 shows an elevational view of a second embodiment of the low-pressure discharge lamp according to the invention.

The figures are purely diagrammatic and not drawn to scale. Particularly for clarity, some dimensions are exaggerated strongle. Similar components are denoted by the same reference numerals as much as possible.

In the embodiment shown in FIG. 1 and FIG. 2, the low-pressure gas discharge lamp in accordance with the invention is composed of a substantially torus-shaped discharge vessel 1, which surrounds a discharge space 2. Means 3 to generate an electromagnetic field are centrally disposed in the form of a heat conductor 3a, which typically equalizes the heat, and a ferrite element 3b, via which the gas discharge present in discharge space 2 can be ignited. Inductive means 3 are connected to the base 10 of the lamp. The low-pressure gas discharge lamp further comprises, in a manner which is known per se, an electrical ballast which is used to control the ignition and the operation of the gas discharge lamp.

The gas discharge vessel 1 may alternatively be embodied so as to be a cylindrical, multiple-bent, dome-shaped, donut-shaped or coiled tube. Discharge vessel 1 is usually surrounded by an outer lamp bulb 4. The wall of the gas discharge vessel is preferably made of a glass type, quartz, aluminum oxide or yttrium-aluminum-granate. It is an advantage of the invention that also the more common and cheaper glass materials can be used, such as for instance soda-lime glass. Between outer lamp bulb 4 and discharge vessel 1 a (partial-) vacuum area 8 is provided, preferably having a pressure below about 2 Pascals, in order to avoid or at least inhibit thermal conductivity. Referring to FIG. 1, the vacuum area is created by evacuation of a dome 11 that is positioned between the discharge vessel 1 and the outer lamp bulb 4. Referring to FIG. 2, the vacuum area 8 is created by evacuation of the inner space of a dome 11 that consists of the outer lamp bulb 4 connected to an inner bulb 12 in an airtight manner. Dependent on the thermal design of the lamp, the vacuum area 8 may be omitted.

Referring to both FIGS. 1 and 2 again, the gas filling used in the gas discharge lamp according to the invention may be any filling known in the art. It is for instance possible to use metal halide fillings, if desired with a noble or inert gas. Examples of suitable gas fillings include indium halide, zinc halide, gallium halide, and other suitable metal halides, possibly supplemented with an inert gas, with a metal such as indium, zinc or gallium, and mixtures of these fillings. It is also possible to use a chalcogenide, for instance of silicon, germanium, tin and/or lead, and an inert gas. The inert gas serves as a buffer gas enabling the gas discharge to be more readily ignited. For the buffer gas use is preferably made of argon. Argon may be substituted, either completely or partly, with another inert gas, such as helium, neon, krypton or xenon.

According to the invention, the gas discharge lamp is provided with a first phosphor coating 5, which, in the embodiments shown, is applied to the inside surface of gas discharge vessel 1 (the coating thickness shown is exaggerated and only schematic). The first phosphor coating 5 is capable to be used at a high temperature, preferably higher than 150° C. Very suitable phosphors to be used as first phosphor include barium magnesium aluminate (BaMgAl₁₀O₁₇:Eu), cerium terbium magnesium aluminate ((Ce, Tb)MgAl₁₁O₁₉), yttrium oxide (Y₂O₃:Eu), magnesium germinate (Mg₄GeO_{5.5}F:Mn), yttrium vanadate and mixtures of these.

It has further been found that, in accordance with an advantageous measure, an increase of the lumen efficiency of the low-pressure gas discharge lamp can be achieved by controlling the operating temperature of the lamp by means of suitable constructional measures, so that during operation an elevated internal temperature within the discharge vessel is maintained. To increase the internal temperature within gas discharge vessel 1, the vessel is preferably coated with an IR radiation-reflecting layer 6 on its outside surface. Preferably, use is made of an infrared radiation-reflecting coating of fluor-doped tin oxide.

The inside surface of the lamp bulb 4 is coated with a second phosphor layer 7. The UV radiation originating from the gas discharge space 2 excites the phosphors in both the first and second phosphor layers 5 and 7 so as to emit light from the lamp in the visible range. The chemical composition of the first and second phosphor layer determines the spectrum of the light and its tone. The materials that can suitably be used as phosphors must absorb the radiation generated and emit said radiation in a suitable wavelength range, for example for the three primary colors red, blue and green, and enable a high fluorescence quantum yield to be achieved.

According to the invention, the second phosphor coating can be selected from a wide range of suitable phosphors, not necessarily those that exhibit a stable behaviour at high temperatures. Suitable second phosphors include for instance yttrium oxy-sulphide europium (Y₂O₂S:Eu), gadolinium oxy-sulphide europium, OSE (CaSrSiO₄:Eu), BOSE ((BaSr)₂SiO₄:Eu), and yttrium aluminium granate cerium, YAG-cerium (Y₃Al₅ O₁₂:Ce³⁺), but others may be used as well.

According to the invention, it is possible to excite the lamp using conventional electrodes, arranged within the gas discharge vessel for example. According to another embodiment, the lamp is capacitively excited using a high-frequency field having a frequency of, for example, 2.65 MHz or 13.56 MHz, where the electrodes are provided on the outside of the gas discharge vessel. It is also possible to provide a lamp that is inductively excited using a high-frequency field having a frequency of, for example, 100 kHz, 2.65 MHz or 13.56 MHz. The lamp may also be electromagnetically excited using typical microwave frequencies, such as 2.4 GHz.

When the lamp is ignited, the excited atoms and molecules of the gas filling emit UV and/or visible radiation from the characteristic radiation and a continuous molecular spectrum. The discharge heats up the gas filling such that the desired vapor pressure and the desired operating temperature are achieved at which the light output is optimal. According to the invention, the discharge 2 generates visible and UV light with typically a main contribution in the UV-A range of wavelengths. The UV-B and UV-C parts of the UV light emitted will at least partly be converted by the first phosphor coating layer 5 to light of longer wavelength. This longer wavelength light is then transmitted through the wall of the discharge vessel 1 together with UV-A light (at least light of longer wavelength than UV-B and UV-C light). In the embodiment shown, infrared reflective layer 6 will reflect the infrared radiation emitted from the discharge vessel 1 and discharge 2, and will heat up the discharge 2. After start-up of the lamp, the UV-C radiation generated from the inert gas will also at least partly be converted by the first phosphor coating layer 5 into visible light. Because the short wavelength radiation has been converted into longer wavelength light before hitting the discharge vessel wall 1, this wall is less prone to discoloration or solarization, and therefore can be made from normal glass, such as soda-lime glass. Second phosphor coating layer 7 will, according to the invention, substantially absorb the UV-A light emitted form the discharge vessel 1, and convert this light to visible light.

In an alternative embodiment, the second phosphor layer 7 is positioned on the outside surface of the gas discharge vessel 1, on top of the IR reflecting layer 6. Referring to FIG. 1, in another alternative embodiment, the IR radiation-reflecting layer 6 is positioned on a side of an inner wall 13 of the dome 11 facing the discharge vessel 1. In a further alternative embodiment, the second phosphor layer 7 is positioned on a side of the outer wall 14 of the dome 11. It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage.

1. A low-pressure gas discharge lamp comprising a gas discharge vessel (1), surrounding a discharge space (2) and containing a gas filling, and further comprising means to generate an electromagnetic field (3) for generating and maintaining a low-pressure gas discharge, characterized in that the discharge lamp is provided with a first phosphor coating (5) on a surface of the gas discharge vessel (1) and with a second phosphor coating (7), the second phosphor coating (7) being provided on a surface of the lamp that is more remote from the discharge space (2) compared to the first phosphor coating (5), and the first phosphor coating (5) being selected from the group of thermally stable phosphors.

2. A low-pressure gas discharge lamp according to claim 1, characterized in that the first phosphor coating (5) is selected from the group consisting of metal aluminates and/or metal oxides.

3. A low-pressure gas discharge lamp according to claim 1, characterized in that the first phosphor coating comprises a UV-A and/or blue emitting phosphor.

4. A low-pressure gas discharge lamp according to claim 3, characterized in that the second phosphor layer comprises a phosphor that is excited when exposed to UV-A and/or blue radiation.

5. A low-pressure gas discharge lamp according to claim 4, characterized in that the gas discharge vessel (1) is provided with the first phosphor coating (5) on its inside surface.

6. A low-pressure gas discharge lamp according to claim 5, characterized in that the gas discharge vessel (1) is provided with the second phosphor coating (7) on its outside surface.

7. A low-pressure gas discharge lamp according to claim 1, characterized in that
the lamp further comprises an outer lamp bulb (4) surrounding the gas discharge vessel (1), and in that
the outer lamp bulb (4) is provided with the second phosphor coating (7).

8. A low-pressure gas discharge lamp according to claim 7, characterized in that the outer lamp bulb (4) is provided with a second phosphor coating (7) on its inside surface.

9. A low-pressure gas discharge lamp according to claim 1, characterized in that the gas discharge vessel (1) is provided with an infrared reflective coating (6).

10. A low-pressure gas discharge lamp according to claim 9, characterized in that the infrared reflective coating (6) is positioned on an outside surface of the gas discharge vessel (1).
